(19) United States
(12) Patent Application Publication
(10) Pub. No.: US 2009/0234817 A1
(43) Pub. Date: Sep. 17, 2009

(54) Method for Generating An Electronic Address Database, Method For Searching An Electronic Address Database And Navigation Device With An Electronic Address Database

(76) Inventor: Harald Kortge, Wurzburg (DE)

Correspondence Address: QUARLES & BRADY LLP, 411 E. WISCONSIN AVENUE, SUITE 2040, MILWAUKEE, WI, 53202-4497, US

(21) Appl. No.: 12/398,845

(22) Filed: Mar. 5, 2009

(30) Foreign Application Priority Data
Mar. 11, 2008 (DE) 10 2008 013 637.9
May 5, 2008 (DE) 10 2008 022 184.8

(51) Int. Cl. G06F 17/30

(52) U.S. Cl. 707/3; 707/102; 707/E17.044; 707/E17.014

(57) ABSTRACT

A method generates an address database that can be stored on an electronic storage medium and in which locations, particularly town names and street names, are described in the form of a plurality of address datasets. The method includes the following steps:
a) loading an original database, in which at least part of a complete data stock of address datasets is stored, into an electronic analyzer,
b) analyzing the address datasets in the original database, wherein several address datasets are respectively recoded into a data section and a delimiting section that is arranged before or after the data section,
c) generating a sequential string of recoded address datasets, in which the data sections are arranged in succession and separated by the respectively assigned delimiting sections, and
d) storing the sequential string of recoded address datasets as a new address database.

This application claims the priority benefit of German Patent Application No. 10 2008 013 637.9 filed on Mar. 11, 2008, and German Patent Application No. 10 2008 022 184.8 filed on May 5, 2008, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a method for generating an electronic address database. The invention furthermore pertains to a method for searching such an address database and a navigation device, on which such an address database is installed. Address databases are required, for example, but by no means exclusively, in navigation devices in order to identify possible destinations. In this case, a certain geographic position or a street element identifier is assigned to each address that consists, for example, of a combination of a town name, a street name and a house number. When the user inputs a certain address, the address database is searched for this address. As soon as the address is found, a certain geographic position can be assigned to the searched address, for example, in a navigation device and a route for driving to this geographic position can subsequently be calculated.

### BACKGROUND OF THE INVENTION

Known address databases frequently have a table or tree structure in order to allow the most efficient search possible. In this case, the address data stock is frequently indexed in order to achieve a high search speed. However, the disadvantage of these indexed address databases can be seen in that substantial storage space is required for storing the address database. In addition, all substrings need to be indexed, wherein this is very complex with street names such as “17^{th} of June Avenue.”

There also exist address databases that allow so-called “smart spelling”. In smart spelling, only correct names can be input because only the letters, for which a selection is actually possible, can be selected depending on the preceding inputs. Smart spelling address databases usually have a tree structure and also require substantial storage space.

### SUMMARY OF THE INVENTION

Based on this prior art, the present invention aims to propose a method for generating a new type of address database that eliminates the disadvantages of the prior art. In particular, the present invention provides a fast and efficient address input as it is required, for example, in navigation systems when only limited resources with respect to the processor capacity and with respect to the storage capacity in the main memory are available. Another objective of the present invention consists of proposing a search method for searching correspondingly generated address data. Furthermore, a navigation device is proposed, on which a thusly generated address database is stored.

### DETAILED DESCRIPTION OF THE PREFERRED EMBODIMENT

An original database, in which the address data is conventionally stored in the form of a plurality of address datasets, forms the basis of the inventive method. For example, the original database may have a table or tree structure. Naturally, the original database may also contain only a portion of the total address data stock required for the operation of a certain device. This original database is initially loaded into an electronic analyzer.

The address datasets contained in the original database are subjected to a data analysis in the analyzer. Each individual address dataset is subsequently recoded into a data section and a delimiting section arranged before or after the data section.

A sequential string of recoded address datasets is subsequently generated from the data sections and the respectively assigned delimiting sections. In this case, all address datasets could be initially recoded and then collectively assembled into a string of recoded address datasets or one respective address dataset could be incrementally recoded in succession and subsequently sorted according to the character string of the recoded address datasets. This sequential character string of data sections and delimiting sections is then stored in the form of a new address database. Thus, according to the invention, an address database is generated, in which the address data is contained in a linear character string (data string). In this case, the character string consists of a chain of data sections and delimiting sections that are respectively arranged alternately. The first and/or last dataset in the character string may also be stored without a delimiting section in this case. A data section and an assigned delimiting section respectively can be explicitly assigned to an address dataset of the original database.

In order to simplify the search for addresses in the string of recoded address datasets, it is particularly advantageous to respectively sort the data sections in the chronological order alphabetically in accordance with the letter sequence. This means that, for example, town names that begin with the “A” are sorted before town names that begin with “B.” This also means that, for example, the town name “Aachen” is sorted before the town name “Aalen” which, in turn, is sorted before the town name “Augsburg.” A delimiting section that may consist, for example, of a single delimiting character or several delimiting characters is respectively arranged between the individual data sections.

Any type of delimiting section may essentially be generated during the recoding of the address datasets, wherein the choice depends on the respective application. In order to simplify the subsequent search of the address database generated in accordance with the invention, it is particularly advantageous to store a consistency value in the delimiting section. In this case, the consistency value characterizes the number of individual characters of the respectively coded address dataset that are consistent with the already recoded address datasets. The evaluation of the consistency value can be very helpful during the search for addresses in the string of recoded address datasets.

The storage of consistency values also makes it possible, in particular, to realize a data compression in the address database in order to reduce the storage space required for storing the address database. This can be achieved during the recoding of an address dataset by respectively comparing this address dataset with the address dataset that was stored last in the string of recoded address datasets with a consistency value “0.” In this case, it is advantageous to use the ASCII value 0 as a consistency value. An address dataset that was stored in the string of recoded address datasets with the consistency value “0” is characterized in that it had no commonalities with the previously stored address datasets in the string of recoded address datasets. As soon as the last address dataset stored in the string of recoded address datasets with the consistency value “0” is identified, the prefix of the address dataset to be currently recoded is compared with the prefix of the address dataset with the consistency value “0.” The number of consistent individual characters of the prefix is then stored as new delimiting section in the form of a prefix consistency value and the address dataset to be recoded is simultaneously stored as a new data section after it has been reduced by the prefix.

For example, if the town names “Aachen,” “Aalen” and “Augsburg” should be stored, Aachen is stored first due to the alphabetic sorting, wherein the delimiting section <0> is arranged before Aachen due to the lacking consistency with a previous address dataset. Consequently, the following character string is initially created: <0> AAchen.

Subsequently, the town name “Aalen” should be stored in the string of recoded address datasets. During the comparison of the town name Aalen with the town name Aachen that was previously stored with the consistency value “0,” it is determined that both town names are consistent with respect to the prefix “AA.” For that reason a prefix consistency value “two” is stored for the town name Aalen in the new delimiting section <2> and the town name “Aalen” is stored in the assigned data section after it has been reduced by the prefix “AA.” The following character chain is created after the storage of this second delimiting section and the second data section:
<0>AACHEN<2>LEN

This means that the prefix “AA” is coded with the delimiting section <2>.

If the town name “Augsburg” should now also be stored in the string of recoded address datasets, Augsburg is once again compared with Aachen because this is the last data section with a prefix consistency value “0.” During this process, it is determined that “Augsburg” is only consistent with “Aachen” with respect to the prefix “A.” For that reason a prefix consistency value “one” is stored in the delimiting section <1> for the address dataset Augsburg. The data section “UGSBURG” is stored after this delimiting section. After the storage of the town name “Augsburg,” the string of recoded address datasets is as shown below after the recoding process:
<0>AACHEN<2>LEN<1>UGSBURG

ASCII characters, for example, with a range of values from 0 to 31, can be used as prefix consistency values in the delimiting section between the town names, wherein the respective numeral indicates the number of identically consistent individual characters in the prefixes of the individual town names.

During the search of the database generated in accordance with the invention, it is also advantageous to respectively store a recoded data section with a consistency value “0” within regular intervals of the string of recoded address datasets. For example, each 32^{nd} address dataset or each 64^{th} address dataset could be transformed into a recoded data section and stored in the string of recoded address datasets in this form. During the search of the address database generated in accordance with the invention, this provides the advantage of enabling continued search inquiries that have already excluded subsets to skip larger blocks of data sections in the string of recoded address datasets. In this case, 32 or 64 data sections respectively form a bit field and can be very effectively checked with current processors.

The address database can be additionally optimized with respect to the required storage space by identifying word fragments that frequently recur in identical form, each having an identical continuous string of individual characters. For example, the word fragment “StraBe” and the word fragment “Weg” occur very frequently in the list of German street names. The word fragments “Stadt”, “Berg” and “Burg” frequently occur in the list of German town names. These identical word fragments can be mapped onto suitably selected token elements with the method described below such that the required storage space can be reduced. For this purpose, word fragments with an identical continuous string of individual characters are initially identified in the address datasets of the original database. In this case, the identified word fragments are characterized in that they are respectively contained in identical form in a plurality of address datasets. A token element such as, for example, a short string of recoded address datasets of ASCII characters is explicitly assigned to each word fragment that was identified in this fashion. The thusly generated token element is stored and can distinctly represent the assigned word fragment during a corresponding inquiry.

During the recoding of an address dataset, it is checked if the address dataset contains one of the stored token elements. If this is the case, the correspondingly identified word fragment of the address dataset is replaced with the assigned token element. In the town name “Augsburg,” for example, the word fragment “burg” can be replaced with the token element “x1.” After the replacement of the word fragment “burg” with the token element “x1” and the reduction in accordance with the above-described sequence, the town name “Augsburg” therefore would be stored in the following form: <1>UGSx1.

The identification of word fragments in the address datasets and their replacement with token elements should only be carried out after the recoding of the prefixes of the address datasets because the prefix-based search of the address datasets generated in accordance with the invention could otherwise not be carried out.

The individual address databases for storing the required address data may essentially be structured in any suitable way. It is preferred to generate a main address database with a string of recoded address datasets for the town names of the original database, wherein this character string then contains all town names of the original database in recoded form.

A subaddress database can also be generated for each town parallel to the main address database, wherein this subaddress database contains the street names of each assigned town in the form of a string of recoded address datasets.

With respect to the street search that takes place after a town was selected, i.e., the town was already determined during the input of an address, the corresponding street (names) relevant to this town could alternatively be determined by identifying the streets that are assigned to the town in the complete list of all streets or the complete list of all streets in the tiles, i.e. the map segments, in which the town is situated. This means that only these streets are taken into account in this case when the inventive method is carried out. Here it is advantageous to use bit fields that assign the value 1=> “true” for “belonging to the town” or 0=> “false” for “not belonging to the town” to each dataset in the complete list of streets after the identification of the town. In the inventive method, these bit fields are used as filters for the complete list of streets that define whether or not a street is taken into account.

It is furthermore advantageous that a street only occurs once in the complete list of streets regardless of the number of towns in which it occurs.

It is also advantageous to normalize the address datasets of the original database, for example the street and town names, to a basic form in a normalizing module prior to the storage in the string of recoded address datasets, namely in accordance with a predetermined normalization scheme. This would result, for example, in the street name “Champs-Elysées” being normalized to the notation “champs elysee,” wherein the upper and lower case, in particular, are also normalized. All other conceivable notations of the same name would also be normalized to a basic form and the amount of data would be reduced accordingly. The search address would also be normalized accordingly during the search in the database.

The address database generated in accordance with the invention also provides significant advantages in the search for addresses, particularly if prefix coding was carried out. During the search for an address component, the corresponding search string is loaded into an electronic search module. The search string is then sequentially compared with the data sections and the delimiting sections in a string of recoded address datasets of the address database. If an inconsistency between the prefix of the search string and the prefix of a data section is identified during this comparison, all data sections that follow this data section and refer to the same prefix by means of their delimiting section are subsequently skipped. This makes it possible to easily skip large blocks of strings of data sections without requiring a comparison of the individual characters in the search string.

If frequently occurring word fragments are coded with token elements in the database, the corresponding word fragments should also be replaced with the prestored token elements in the search string during the search for individual addresses. The search can be simplified in this fashion by comparing the respective token elements.

It is furthermore advantageous to generate an index for so-called critical paths during the generation of the database. For example, critical paths are letters or letter combinations that occur in a large number of datasets.

If the address database has a hierarchic structure with a main address database for storing the town names and a plurality of subaddress databases for storing the street names in the individual cities, the search is also carried out step-by-step. In other words, a search for the town name is initially carried out in the main address database and the subaddress database that is assigned to the town found in the main address database and contains the street names of the town is subsequently searched.

The address database generated in accordance with the invention can essentially be used in all suitable types of devices. The address database generated in accordance with the invention is particularly advantageous in navigation devices, especially in mobile navigation devices, because the inventive address database not only makes it possible to reduce the required storage space, but also the required processor performance.

Due to the data reduction, it is also possible, in particular, to store the address database in the permanent memory, as well as in the main memory, of the navigation device.

If the address database is used in a navigation device, a certain geographic position or a street element identifier should be assigned to each address of the address database.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for generating an address database that can be stored on an electronic storage medium and in which locations, particularly town names and street names, are described in the form of a plurality of address datasets, wherein said method comprises the following steps:
a) loading an original database, in which at least part of a complete data stock of address datasets is stored, into an electronic analyzer;
b) analyzing the address datasets in the original database, wherein several address datasets are respectively recoded into a data section and a delimiting section that is arranged before or after the data section;
c) generating a sequential string of recoded address datasets, in which the data sections are arranged in succession and separated by the respectively assigned delimiting sections; and
d) storing the sequential string of recoded address datasets as a new address database.

2. The method according to claim 1, in which the data sections are sorted alphabetically in the sequential string of recoded address datasets.

3. The method according to claim 1, in which during the recoding of an address dataset, the address dataset is analyzed with respect to how many continuous individual characters the address dataset is consistent with an already recoded address dataset, wherein the number of consistent individual characters is stored in the form of a consistency value in the assigned delimiting section.

4. The method according to claim 3, in which, during the recoding of an address dataset, this address dataset is compared with the address dataset that was stored last in the sequential string of recoded address datasets with a consistency value zero, wherein the address dataset is subsequently analyzed with respect to how many continuous individual characters the prefix of the address dataset is consistent with this already recoded address dataset, wherein the number of consistent individual characters of the prefix is stored as new delimiting section in the form of a prefix consistency value, and wherein the address dataset is stored as a new data section after the address dataset has been reduced by the prefix.

5. The method according to claim 3, in which a recoded data section with a consistency value zero is stored within regular intervals of the sequential string of recoded address datasets, particularly after 32 or 64 respective data sections.

6. The method according to claim 1, in which word fragments that consist of an identical string of continuous individual characters and are respectively contained in identical form in a plurality of address datasets are identified in the address datasets of the original database, wherein a token element is explicitly assigned to each of these word fragments and stored, wherein each token element represents the string of continuous individual characters of a word fragment, wherein word fragments in the address datasets are identified during the recoding of an address dataset by means of a comparison with the stored token elements, and wherein each word fragment identified in an address dataset is replaced with the assigned token element.

7. The method according to claim 6, in which the identification of the word fragments in an address dataset, as well as the replacement with a token element, is carried out after the recoding of the prefix of the address dataset.

8. The method according to claim 1, in which a main address database with a sequential string of recoded address datasets is generated for the town names of the original database.

9. The method according to claim 1, in which a subaddress database with a sequential string of recoded address datasets is generated for the street names of each town of the original database.

10. The method according to claim 1, in which the address datasets of the original database are normalized to a basic form in a normalizing module in accordance with a predetermined normalization scheme.

11. A method for searching an address database that is stored on an electronic storage medium and has been generated in accordance with a method according to claim 1, wherein
a) a search string is loaded into an electronic search module,
b) the search string is sequentially compared with the data sections and delimiting sections in the sequential string of recoded address datasets of the address database, wherein the identification of an inconsistency between the prefix of the search string and the prefix of a data section results in all data sections that follow this data section and refer to the prefix of this data section by means of their delimiting section being skipped.

12. The method according to claim 11, in which word fragments that consist of continuous individual characters and have been assigned a token element during the generation of the address database are identified in the search string, wherein the word fragment of the search string is replaced with the token element.

13. The method according to claim 11, in which, after inputting a search address with a town name and a street name, a main address database with all town names stored in the sequential string of recoded address datasets of the main address database is initially searched, and the subaddress database with all street names of the town stored in the sequential string of recoded address datasets of the subaddress database that is stored for the town identified during the search in the main address database is subsequently searched.

14. A navigation device with a memory, in which a digital address database is stored, in which the address database was generated with a method according to claim 1.

15. The navigation device according to claim 14, in which the address database is stored in the permanent memory and in the main memory of the navigation device.

16. The navigation device according to claim 14, in which a certain geographic position or a street element identifier is assigned to each address in the sequential string of recoded address datasets of the address database.
